(19) United States
(12) Patent Application Publication
(10) Pub. No.: US 2026/0129553 A1
(43) Pub. Date: May 7, 2026

(54) NETWORK DISCOVERY VIA AN ACCESS POINT WHILE A MOBILE DEVICE IS IN A WIRELESS OFF MODE

(71) Applicant: Charter Communications Operating, LLC, St. Louis, MO (US)

(72) Inventors: Rohith Kumar Punithavel, Englewood, CO (US); Mohamed Daoud, Aurora, CO (US); Hany Heikal, Aurora, CO (US); Hossam H. Hmimy, Aurora, CO (US)

(21) Appl. No.: 18/934,347

(22) Filed: Nov. 1, 2024

(51) Int. Cl. H04W 48/04; H04W 48/16

(52) U.S. Cl. CPC H04W 48/04; H04W 48/16

(57) ABSTRACT

A mobile device determines that the mobile device is in a wireless off mode, the wireless off mode comprising a mode wherein the mobile device does not automatically connect to a wireless access point (WAP) to which the mobile device has previously connected. The mobile device determines that the mobile device is in proximity to a first WAP to which the mobile device has previously connected. The mobile device connects to the first WAP. The mobile device discovers a first output device connected to the first WAP, and establishes with the first output device a peer-to-peer wireless connection.

### BACKGROUND

In order to discover devices on a network to which a mobile device may want to send content, such as video content or audio content, the mobile device must connect to the network. If the mobile device is in a wireless off mode, the mobile device will not automatically connect to a known wireless network for which the mobile device has authentication credentials.

### SUMMARY

The examples disclosed herein implement network discovery via an access point while a mobile device is in a wireless off mode.

In one implementation a method is provided. The method includes determining, by the mobile device, that the mobile device is in a wireless off mode, the wireless off mode comprising a mode wherein the mobile device does not automatically connect to a wireless access point (WAP) to which the mobile device has previously connected. The method further includes determining, by the mobile device, that the mobile device is in proximity to a first WAP to which the mobile device has previously connected. The method further includes connecting, by the mobile device, to the first WAP. The method further includes discovering, by the mobile device, a first output device connected to the first WAP. The method further includes establishing, by the mobile device with the first output device, a peer-to-peer wireless connection.

In another implementation a computing device is provided. The computing device includes a memory, and a processor device coupled to the memory. The processor device is operable to determine that the mobile device is in a wireless off mode, the wireless off mode comprising a mode wherein the mobile device does not automatically connect to a wireless access point (WAP) to which the mobile device has previously connected. The processor device is further operable to determine that the mobile device is in proximity to a first WAP to which the mobile device has previously connected. The processor device is further operable to connect to the first WAP. The processor device is further operable to discover a first output device connected to the first WAP. The processor device is further operable to establish, with the first output device, a peer-to-peer wireless connection.

In another implementation a non-transitory computer-readable storage medium is provided. The non-transitory computer-readable storage medium includes executable instructions operable to cause a processor device to determine that the mobile device is in a wireless off mode, the wireless off mode comprising a mode wherein the mobile device does not automatically connect to a wireless access point (WAP) to which the mobile device has previously connected. The instructions are further operable to cause the processor device to determine that the mobile device is in proximity to a first WAP to which the mobile device has previously connected. The instructions are further operable to cause the processor device to connect to the first WAP. The instructions are further operable to cause the processor device to discover a first output device connected to the first WAP, and establish, with the first output device, a peer-to-peer wireless connection.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1B are block diagrams of an environment in which network discovery via an access point while a mobile device is in a wireless off mode can be practiced according to some implementations;

FIG. 2 is a flowchart of a method for network discovery via an access point while a mobile device is in a wireless off mode according to some implementations; and

FIG. 3 is a block diagram of a computing device suitable for implementing network discovery via an access point while a mobile device is in a wireless off mode according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together

In order to discover devices on a network to which a mobile computing device (hereinafter “mobile device” for the sake of brevity) may want to send content, such as video content or audio content, the mobile device must connect to the network. If the mobile device is in a wireless off mode, the mobile device will not automatically connect to a known wireless network for which the mobile device has authentication credentials.

There are situations where it may be desirable for a mobile device to establish a peer-to-peer connection with another device on a network so that the mobile device can send data to the other device. For example, a user of a mobile device may want to mirror the screen of the mobile device to a television connected to the network, or stream content from a content streaming application to the television. In practice this capability is implemented via a network discovery mechanism wherein the mobile device can request, via the access point (AP), information about other network connected devices. The AP provides the requested information, and the mobile device can establish a peer-to-peer connection with the television that does not go through the AP.

In order for network discovery to operate the mobile device must be connected to the AP. A user often sets a mobile device into a wireless off mode such that the mobile device does not automatically connect to an AP to which the mobile device previously connected. There are any number of reasons a user might set the mobile device into the wireless off mode, such as, by way of non-limiting example, a desire not to send data through a work network, for security purposes where the user is not sure an available AP can be trusted, or because at a particular location a user obtains greater bandwidth via a cellular connection than the available wireless network.

The user may subsequently move within proximity of a known wireless network, such as a home wireless network, and forget that the mobile device has been set to the wireless off mode. The user may desire to send content to a connected speaker device but without connecting to the AP the mobile device will not be able to discover the connected speaker device. The user may not realize why she is unable to select the connected speaker device, resulting in frustration or delay in causing the content to be sent to the connected speaker device. Additionally or alternatively, the user may have a desire not to connect the mobile device to the Internet because doing so may automatically cause activity on the mobile device that the user does not wish to occur.

The examples disclosed herein implement network discovery via an access point while a mobile device is in a wireless off mode. In particular, the examples disclosed herein relate to a mobile device that determines that the mobile device is in a wireless off mode, the wireless off mode comprising a mode wherein the mobile device does not automatically connect to a wireless access point (WAP) to which the mobile device has previously connected. The mobile device determines that the mobile computing device is in proximity to a WAP to which the mobile computing device has previously connected. Even though the mobile device is in the wireless off mode, the mobile device connects to the WAP. The mobile device discovers an output device connected to the WAP. The mobile device establishes a peer-to-peer wireless connection with the output device and sends data to the output device.

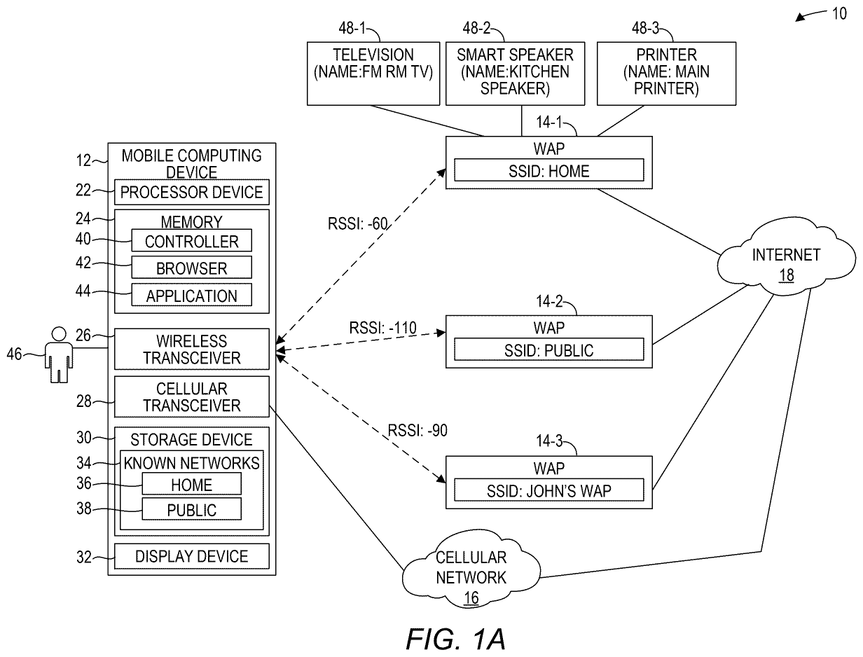

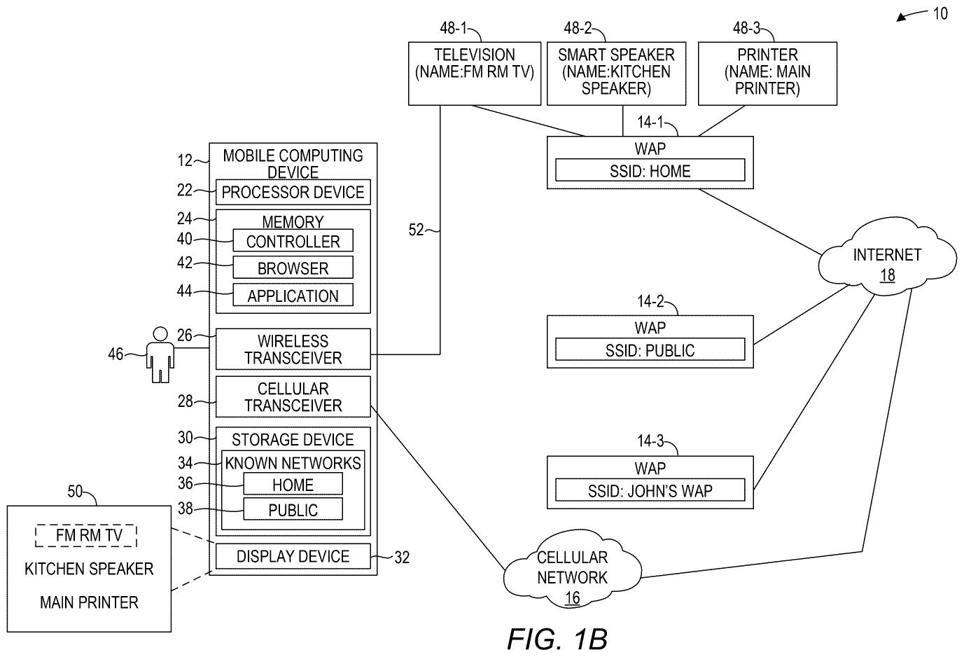

FIGS. 1A-1B are block diagrams of an environment 10 in which network discovery via an access point while a mobile device is in a wireless off mode can be practiced according to some implementations. The environment 10 includes a mobile computing device 12 (hereinafter mobile device 12 for the sake of brevity), three WAPs 14-1-14-3 (generally, WAPs 14), and a cellular network 16. The WAPs 14 and the cellular network 16 are each connected to the Internet 18.

The WAPs 14 may be integrated with a router, and manage authentication of mobile devices that wish to connect to the WAPs 14, and also manage and control access by a mobile device to the Internet 18. The WAPs 14 periodically, such as every 100 milliseconds (ms) or any other suitable interval of time, broadcast beacon frames that identify a service set identifier (SSID) of the network implemented by the WAPs 14. In this example, the WAP 14-1 implements a network named “HOME” and thus broadcasts an SSID 20-1 (“HOME”), the WAP 14-2 implements a network named “PUBLIC” and thus broadcasts an SSID 20-2 (“PUBLIC”), and the WAP 14-3 implements a network named “JOHN'S WAP” and thus broadcasts an SSID 20-3 (“JOHN'S WAP”).

The mobile device 12 includes a processor device 22, a memory 24, a wireless transceiver 26 operable to communicate with a WAP 14, a cellular transceiver 28 operable to communicate with the cellular network 16, a storage device 30 and a display device 32. The mobile device 12 maintains known network information 34 that retains information, such as an SSID and authentication information, such as a password, regarding wireless networks to which the mobile device 12 has previously connected. In this example, the known network information 34 includes an entry 36 that contains the SSID and authentication information for the network implemented by the WAP 14-1 indicating that the mobile device 12 has previously connected to the WAP 14-1. The known network information 34 also includes an entry 38 that contains the SSID and authentication information for the network implemented by the WAP 14-2 indicating that the mobile device 12 has previously connected to the WAP 14-2. The known network information 34 does not include an entry associated with the network implemented by the WAP 14-3, indicating that the mobile device 12 has not previously connected to the WAP 14-3.

The mobile device 12 includes a controller 40 that implements certain functionality as described herein, a browser 42 operable to communicate with websites via the Internet 18, and an application 44 that is operable to stream content to a device, such as a television, a network connected speaker, or the like. While for purposes of illustration the controller 40 is illustrated as a separate component, in other implementations the functionality attributed herein to the controller 40 may be implemented via one or more other components that execute on the mobile device 12, such as an operating system or the like.

With this background an example of network discovery via an access point while a mobile device is in a wireless off mode will be discussed. Assume that a user 46 of the mobile device 12, while at a work location that is not in wireless communication proximity of the WAPs 14, sets the mobile device 12 to a wireless off mode. The wireless off mode of the mobile device 12 disconnects the mobile device 12 from any wireless network to which the mobile device 12 is currently connected, and prevents the mobile device 12 from automatically connecting to other wireless networks, such as the HOME network implemented by the WAP 14-1 or the PUBLIC network implemented by the WAP 14-2.

The precise way which the mobile device 12 is set to the wireless off mode may differ depending on the particular implementation. If the mobile device 12 is an Apple® iPhone®, the user 46 may go to a Settings application, select a Wi-Fi feature, and then move a toggle switch button to the off position. If the mobile device 12 uses an Android® operating system, the user 46 may go to a Settings application, select a Network & Internet feature, select a Wi-Fi feature, and then move a toggle switch button to the off position. Irrespective of the particular implementation, the term “wireless off mode” as used herein refers to a mode wherein a mobile device is disconnected from any wireless network to which the mobile device is currently connected, and prevents the mobile device from automatically connecting to a WAP that is broadcasting an SSID of a network to which the mobile device has previously connected.

The user 46 subsequently goes to his residence where the mobile device 12 is in proximity of each of the WAPs 14. The controller 40, despite being in the wireless off mode, continuously, such as every 100 milliseconds, every 0.5 seconds, or any other suitable interval of time, or in response to some event, scans the relevant wireless frequencies for beacon frames identifying an SSID of a WAP that is in wireless proximity of the mobile device 12. Scanning to identify any such WAPs may be in response to an action by the user 46. For example, the user 46 may interact with the mobile device 12 to mirror the screen of the mobile device 12 to an output device. In response, the mobile device 12 may begin scanning to identify any WAPs in proximity to the mobile device 12. In another example, the user 46 may be viewing content on a streaming application, such as the application 44. The application 44 may include an option to stream the content to a connected output device. The user 46 may select the option, and in response, the mobile device 12 may begin scanning to identify any WAPs in proximity to the mobile device 12.

In an Android implementation, the controller 40 may scan the relevant wireless frequencies by the following actions:
WifiManager.startScan( )ACTION_REQUEST_SCAN_ALWAYS_AVAILABLE, and WifiManager.getScanResults( ).

In this example, the controller 40 determines that three networks are in proximity to the mobile device 12, the HOME network implemented by the WAP 14-1, the PUBLIC network implemented by the WAP 14-2, and the JOHN'S WAP network implemented by the WAP 14-3. The controller 40 may determine the signal strength of the three WAPs 14 to determine which WAP 14 is the closest WAP 14. In an Android implementation, the controller 40 may determine the signal strength of the three WAPs 14 by the following action: WifiNetworkSuggestion ( ). In this example, the WAP 14-1 has a received signal strength indicator (RSSI) of −60 and thus has the strongest signal, the WAP 14-3 has an RSSI of −90 and thus has the second strongest signal, and the WAP 14-2 has an RSSI of −110 and thus the weakest signal.

The controller 40 may then access the known network information 34 to determine to which of the three networks the mobile device 12 has previously connected. In an Android implementation, the controller 40 may make this determination by the following action: WifiManager.getConfiguredNetworks( ).

The controller 40 determines that the mobile device 12 has previously connected to the WAP 14-1 and the WAP 14-2. Because the WAP 14-1 has the strongest signal and because the mobile device 12 has previously connected to the WAP 14-1, the controller 40 selects the WAP 14-1. Despite the mobile device 12 being in the wireless off mode, the controller 14-1 establishes a connection with the WAP 14-1. In an Android implementation, the controller 40 may establish the connection by the following actions: NetworkSpecifier( ), NetworkRequest.Builder( ).

The controller 14-1 may establish the connection to the WAP 14-1 such that the mobile device 12 cannot access the Internet 18 via the WAP 14-1. In an Android implementation, the mobile device 12 may inhibit any application executing on the mobile device 12 from accessing the Internet 18 via the WAP 14-1 through using a network callback with ConnectivityManager.NetworkCallback to monitor network changes or disconnect from certain networks. In particular, the mobile device 12 can receive events, such as when a WAP 14 becomes available or unavailable to act on such events to block access.

Below is pseudocode suitable in one implementation for preventing an application executing on the mobile device 12 from accessing the Internet 18 via the WAP 14-1.

```
//Custom Callback
NetworkCallback custom_callback = new
ConnectivityManager.NetworkCallback( )
{
public void wifioff( )
# if Wi-Fi is off
  if cellular_active( )
{
# allow cellular connection
}
    else
{
# restrict internet to apps
}
}
public void wifion( )
{
# terminate process
}
}
```

The controller 40 may then, via network discovery, discover output devices connected to the WAP 14-1. In an Android® implementation, the controller 40 may discover output devices connected to the WAP 14-1 by the following action(s): NsdManager. In this example three output devices are connected to the HOME network. A television 48-1 that has been given the name “FM RM TV” is connected to the WAP 14-1, a smart speaker 48-2 that has been given the name “KITCHEN SPEAKER” is connected to the WAP 14-1, and a printer 48-3 that has been given the name “MAIN PRINTER” is connected to the WAP 14-3.

Referring now to FIG. 1B, the controller 40 may generate a user-selectable user interface (UI) control 50 that lists the three output devices 48-1, 48-2 and 48-3 and present the UI control 50 on the display device 32. In this example, the UI control 50 was presented in response to the user 46 requesting, via the application 44, to stream content from the application 44 to an output device.

In this example, the application 44 may comprise a video streaming application and the user 46 selects the television 48-1 identified in the UI control 50. The controller 40 receives the user input selecting the television 48-1. The controller 40 then establishes a peer-to-peer (P2P) wireless connection 52 with the television 48-1 that does not utilize the WAP 14-1. In an Android® implementation the controller 40 may establish the P2P wireless connection 52 with the television 48 via WiFiP2pManager function. In some implementations the controller 40 may terminate the connection with the WAP 14-1. The application 44 receives content via the cellular transceiver 28 and streams the content to the television 48-1 via the P2P wireless connection 52. In some implementations the controller 40 may facilitate streaming to the television 48-1 via an NsdManager.resolveService( ) function.

In some implementations the device discovery process may return metadata that describes capabilities of the output devices 48-1-48-3. The metadata may indicate, for example, that the television 48-1 is capable of receiving video content or audio content, the smart speaker is capable of receiving only audio content, and the printer 48-3 is not capable of receiving either audio content or video content, and is capable of receiving data formatted for printing. The controller 40 may use this information to filter the output devices 48-1-48-3 based on the desired action of the user 46. For example, in the example where the user 46 requests, via the application 44, to stream video content from the application 44 to an output device, the controller 40 may present to the user 46 only the television 48-1, and not identify the smart speaker 48-2 or the printer 48-3. In an example where the application 44 is a word processing application the controller 40 may present to the user only the printer 48-3, and not identify the television 48-1 or the smart speaker 48-2.

It is noted that, because the controller 40 is a component of the mobile device 12, functionality implemented by the controller 40 may be attributed to the mobile device 12 generally. Moreover, in examples where the controller 40 comprises software instructions that program the processor device 22 to carry out functionality discussed herein, functionality implemented by the controller 40 may be attributed herein to the processor device 22.

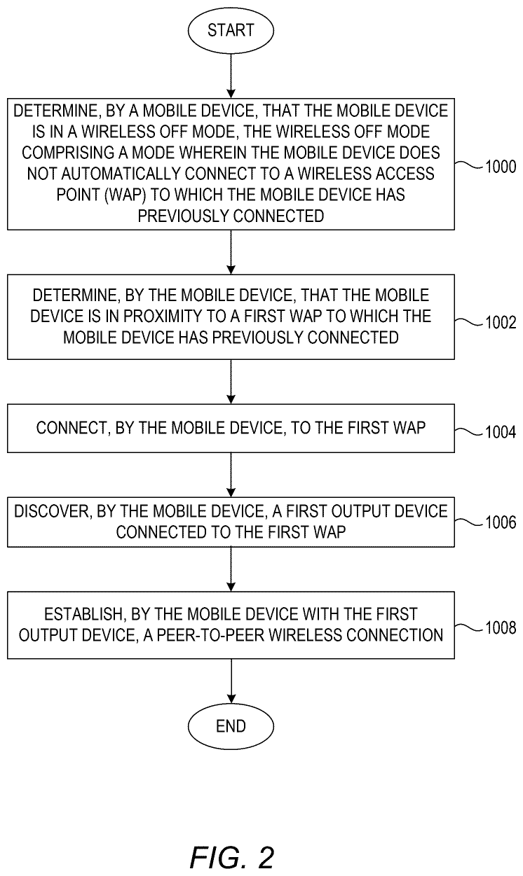

FIG. 2 is a flowchart of a method for network discovery via an access point while a mobile device is in a wireless off mode according to some implementations. FIG. 2 will be discussed in conjunction with FIGS. 1A and 1B. The mobile device 12 determines that the mobile device 12 is in a wireless off mode, the wireless off mode comprising a mode wherein the mobile device 12 does not automatically connect to a WAP to which the mobile device 12 has previously connected (FIG. 2, block 1000). The mobile device 12 determines that the mobile device 12 is in proximity to the WAP 14-1 to which the mobile device 12 has previously connected (FIG. 2, block 1002). The mobile device 12 connects to the WAP 14-1 (FIG. 2, block 1004). The mobile device 12 discovers the output device 48-1 connected to the WAP 14-1 (FIG. 2, block 1006). The mobile device 12 establishes, with the output device 48-1, the peer-to-peer wireless connection 52 (FIG. 2, block 1008).

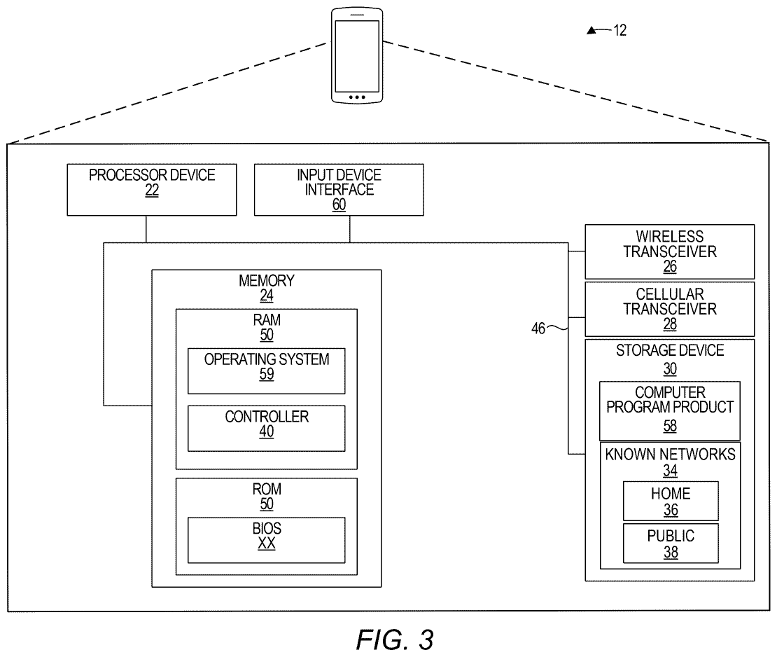

FIG. 3 is a block diagram of the mobile device 12 suitable for implementing network discovery via an access point while the mobile device 12 is in the wireless off mode. The mobile device 12 may comprise any computing or electronic device capable of including firmware, hardware, and/or executing software instructions to implement the functionality described herein, such as a laptop computing device, a smartphone, a computing tablet, or the like. The mobile device 12 includes the processor device 22, the system memory 24, and a system bus 54. The system bus 54 provides an interface for system components including, but not limited to, the system memory 24 and the processor device 22. The processor device 22 can be any commercially available or proprietary processor.

The system bus 54 may be any of several types of bus structures that may further interconnect to a memory bus (with or without a memory controller), a peripheral bus, and/or a local bus using any of a variety of commercially available bus architectures. The system memory 24 may include non-volatile memory 56 (e.g., read-only memory (ROM), erasable programmable read-only memory (EPROM), electrically erasable programmable read-only memory (EEPROM), etc.), and volatile memory 58 (e.g., random-access memory (RAM)). A basic input/output system (BIOS) 60 may be stored in the non-volatile memory 56 and can include the basic routines that help to transfer information between elements within the mobile device 12. The volatile memory 58 may also include a high-speed RAM, such as static RAM, for caching data.

The mobile device 12 may further include or be coupled to a non-transitory computer-readable storage medium such as the storage device 30, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 30 and other drives associated with computer-readable media and computer-usable media may provide non-volatile storage of data, data structures, computer-executable instructions, and the like.

A number of modules can be stored in the storage device 30 and in the volatile memory 58, including an operating system 59 and one or more program modules, such as the controller 40, which may implement the functionality described herein in whole or in part. In some implementations the controller 40 may be integrated into another component or components, such as the operating system 59. All or a portion of the examples may be implemented as a computer program product 62 stored on a transitory or non-transitory computer-usable or computer-readable storage medium, such as the storage device 30, which includes complex programming instructions, such as complex computer-readable program code, to cause the processor device 22 to carry out the steps described herein. Thus, the computer-readable program code can comprise software instructions for implementing the functionality of the examples described herein when executed on the processor device 22. The processor device 22, in conjunction with the controller 40 in the volatile memory 58, may serve as a controller, or control system, for the mobile device 12 that is to implement the functionality described herein.

An operator, such as the user 46, may also be able to enter one or more configuration commands through a keyboard (not illustrated), a pointing device such as a mouse (not illustrated), or a touch-sensitive surface such as the display device 32. The mobile device 12 may also include one or more communication interfaces, such as the wireless transceiver 26 and the cellular transceiver 28.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a mobile device, that the mobile device is in a wireless off mode, the wireless off mode comprising a mode wherein the mobile device does not automatically connect to a wireless access point (WAP) to which the mobile device has previously connected;
determining, by the mobile device, that the mobile device is in proximity to a first WAP to which the mobile device has previously connected;
connecting, by the mobile device, to the first WAP;
discovering, by the mobile device, a first output device connected to the first WAP; and
establishing, by the mobile device with the first output device, a peer-to-peer wireless connection.

2. The method of claim 1, wherein determining that the mobile device is in proximity to the first WAP to which the mobile device has previously connected further comprises:
receiving, by the mobile device from the first WAP, a beacon frame identifying a service set identifier (SSID) of the first WAP.

3. The method of claim 1, further comprising:
determining, by the mobile device, that the mobile device is in proximity to a plurality of WAPs including the first WAP;
prior to connecting to the first WAP:
determining, by the mobile device, a signal strength of each WAP of the plurality of WAPS;
determining, by the mobile device, that a signal strength of the first WAP is greater than a signal strength of any other WAP of the plurality of WAPs; and
wherein connecting to the first WAP further comprises connecting to the first WAP at least in part based on determining that the signal strength of the first WAP is greater than the signal strength of any other WAP of the plurality of WAPs.

4. The method of claim 3, further comprising:
prior to connecting to the first WAP:
determining, by the mobile device, that the mobile device has previously connected to the first WAP; and
wherein connecting to the first WAP further comprises connecting to the first WAP at least in part based on determining that the signal strength of the first WAP is greater than the signal strength of any other WAP of the plurality of WAPs and determining that the mobile device has previously connected to the first WAP.

5. The method of claim 1, further comprising:
inhibiting, by the mobile device, any application executing on the mobile device from accessing the Internet via the first WAP.

6. The method of claim 1, further comprising:
discovering, by the mobile device, a plurality of output devices including the first output device;
presenting, on a display device, a list that identifies the plurality of output devices;
receiving by the mobile device, user input selecting the first output device; and
wherein establishing, with the first output device, the peer-to-peer wireless connection further comprises establishing, with the first output device, the peer-to-peer wireless connection in response to the user input.

7. The method of claim 1, further comprising:
inhibiting, by the mobile device, any application executing on the mobile device from accessing the Internet via the first WAP;
receiving, by the mobile device via a cellular transceiver, data; and
sending, by the mobile device to the first output device, the data

8. The method of claim 1, further comprising sending, by the mobile device to the first output device, data.

9. The method of claim 1, wherein connecting to the first WAP further comprises connecting, by the mobile device, to the first WAP without user input.

10. The method of claim 1, wherein connecting to the first WAP further comprises:
accessing, by the first WAP, authentication credentials; and
connecting, by the mobile device, to the first WAP using the authentication credentials.

11. A computing device, comprising:
a memory; and
a processor device coupled to the memory and being operable to:
determine that the mobile device is in a wireless off mode, the wireless off mode comprising a mode wherein the mobile device does not automatically connect to a wireless access point (WAP) to which the mobile device has previously connected;
determine that the mobile device is in proximity to a first WAP to which the mobile device has previously connected;
connect to the first WAP;
discover a first output device connected to the first WAP; and
establish, with the first output device, a peer-to-peer wireless connection.

12. The computing device of claim 11, wherein the processor device is further operable to:
determine that the mobile device is in proximity to a plurality of WAPs including the first WAP;
prior to connecting to the first WAP:
determine a signal strength of each WAP of the plurality of WAPS;
determine that a signal strength of the first WAP is greater than a signal strength of any other WAP of the plurality of WAPs; and
wherein to connect to the first WAP, the processor device is further operable to connect to the first WAP at least in part based on determining that the signal strength of the first WAP is greater than the signal strength of any other WAP of the plurality of WAPs.

13. The computing device of claim 12, wherein the processor device is further operable to:
prior to connecting to the first WAP:
determine that the mobile device has previously connected to the first WAP; and
wherein to connect to the first WAP, the processor device is further operable to connect to the first WAP at least in part based on determining that the signal strength of the first WAP is greater than the signal strength of any other WAP of the plurality of WAPs and determining that the mobile device has previously connected to the first WAP.

14. The computing device of claim 11, wherein the processor device is further operable to inhibit any application executing on the mobile device from accessing the Internet via the first WAP.

15. The computing device of claim 11, wherein the processor device is further operable to:
discover a plurality of output devices including the first output device;
present, on a display device, a list that identifies the plurality of output devices;
receive user input selecting the first output device; and
wherein to establish, with the first output device, the peer-to-peer wireless connection, the processor device is further operable to establish, with the first output device, the peer-to-peer wireless connection in response to the user input.

16. A non-transitory computer-readable storage medium that includes executable instructions operable to cause a processor device to:
determine that a mobile device is in a wireless off mode, the wireless off mode comprising a mode wherein the mobile device does not automatically connect to a wireless access point (WAP) to which the mobile device has previously connected;
determine that the mobile device is in proximity to a first WAP to which the mobile device has previously connected;
connect to the first WAP;
discover a first output device connected to the first WAP; and
establish, with the first output device, a peer-to-peer wireless connection.

17. The non-transitory computer-readable storage medium of claim 16, wherein the instructions are further operable to cause the processor device to:
determine that the mobile device is in proximity to a plurality of WAPs including the first WAP;
prior to connecting to the first WAP:
determine a signal strength of each WAP of the plurality of WAPS;
determine that a signal strength of the first WAP is greater than a signal strength of any other WAP of the plurality of WAPs; and
wherein to connect to the first WAP, the instructions are further operable to cause the processor device to connect to the first WAP at least in part based on determining that the signal strength of the first WAP is greater than the signal strength of any other WAP of the plurality of WAPs.

18. The non-transitory computer-readable storage medium of claim 17,
wherein the instructions are further operable to cause the processor device to:
prior to connecting to the first WAP:
determine that the mobile device has previously connected to the first WAP; and
wherein to connect to the first WAP, the instructions are further operable to cause the processor device to connect to the first WAP at least in part based on determining that the signal strength of the first WAP is greater than the signal strength of any other WAP of the plurality of WAPs and determining that the mobile device has previously connected to the first WAP.

19. The non-transitory computer-readable storage medium of claim 16, wherein the instructions are further operable to cause the processor device to inhibit any application executing on the mobile device from accessing the Internet via the first WAP.

20. The non-transitory computer-readable storage medium of claim 16,
wherein the instructions are further operable to cause the processor device to:
discover a plurality of output devices including the first output device;
present, on a display device, a list that identifies the plurality of output devices;
receive user input selecting the first output device; and
wherein to establish, with the first output device, the peer-to-peer wireless connection, the instructions are further operable to cause the processor device to establish, with the first output device, the peer-to-peer wireless connection in response to the user input.
